(19) United States
(12) Patent Application Publication
(10) Pub. No.: US 2025/0307689 A1
(43) Pub. Date: Oct. 2, 2025

(54) ADAPTATION FRAMEWORK AND OPTIMIZATION FOR CUSTOMIZING FOUNDATION MODELS

(71) Applicant: Amazon Technologies, Inc., Seattle, WA (US)

(72) Inventors: Nikolaos Pappas, Seattle, WA (US); Momchil Emilov Hardalov, Barcelona (ES); Thomas Müller, Albalat dels Sorells (ES); Miguel Ballesteros Martinez, New York, NY (US); Dan Roth, Philadelphia, PA (US); Georgiana Dinu, New York, NY (US); Luis Marquez Villodre, Gurb (ES)

(21) Appl. No.: 18/617,372

(22) Filed: Mar. 26, 2024

(51) Int. Cl. G06N 20/00

(52) U.S. Cl. CPC G06N 20/00

(57) ABSTRACT

Systems and methods for providing efficient determination of coefficients used for vector arithmetic when generating a new foundational model according to a user's desired modification of a base foundational model. The system evaluates metrics of a new model's performance, including computing perplexity for different coefficients of the new model in parallel.

### BACKGROUND

Foundation models are an artificial intelligence (AI) model that is trained on broad data such that the foundation model can be applied across a wide range of use cases. Foundation models arise from extensive multi-stage training and are expected to perform well on downstream operations. However, these models may lack specialized capabilities on particular domains which are scarce on public datasets. Foundation models can generally perform well on static, one-time finetuning and pretraining settings, but multi-task model performance on a target domain may produce regression.

One technique for increasing performance of a model on a target domain is fine tuning by training. Using fine tuning by training, parameters of an existing model are further trained according to a data set corresponding to a target domain. This can improve performance of the fine-tuned model in that domain. However, fine tuning by training is often time consuming and costly (e.g., in terms of computing resources used). In addition, training foundation models on new domains and tasks sequentially can lead to forgetting previously learned capabilities, deviating from human alignment and resulting to lack of robustness.

### BRIEF DESCRIPTION OF THE DRAWINGS

Throughout the drawings, reference numbers may be re-used to indicate correspondence between referenced elements. The drawings are provided to illustrate example embodiments described herein and are not intended to limit the scope of the disclosure.

FIGS. 1A-1D are exemplary weight vectors and arithmetic operations for editing models, which provide information for underlying arithmetic operations and weight vectors for the systems and methods disclosed herein.

FIG. 2 is a block diagram of an example operating environment in which a machine learning (ML) delivery system may operate to efficiently determine coefficients for model combination through weight vector arithmetic based on communication with client computing devices, model and data providers, and a network.

FIG. 3 is a flow diagram flow diagram depicting example interactions for efficiently determining coefficients for model combination through weight vector arithmetic by processing calls to a front end of a machine learning delivery system in accordance with aspects of the present disclosure.

FIG. 4 is a flow chart depicting an example routine for efficiently determining coefficients for model combination through weight vector arithmetic in accordance with aspects of the present disclosure.

FIG. 5 is a block diagram depicting a general architecture of a computing device that operates to efficiently determine coefficients for model combination through weight vector arithmetic in accordance with aspects of the present disclosure.

### DETAILED DESCRIPTION

Generally described, aspects of the present disclosure relate to arithmetic operations to fine tune ML models, such as foundation models, without requiring additional training. More specifically, aspects of the present disclosure relate to efficiently determining coefficients for the arithmetic operations in a way that enables high accuracy of the fine-tuned model using fewer computing resources than alternative techniques. As used herein, a machine learning model is a computerized mathematical model capable of accepting an input and providing a desired output. For example, a “sequence to sequence” machine learning model may accept a text prompt and provide a corresponding output, such as an answer to a question posed in the text prompt. Machine learning models operate on the basis of parameters (also called weights) that mathematically transform the input into the output. Typically, these parameters are learned over a process known as training, which often includes randomly initializing the parameters and then adjusting them as the model attempts to match training data-a set of known inputs and outputs. Training can be extremely time and resource intensive, in some cases taking months or years of computing power from large distributed systems. Often, models are purpose-specific, and obtaining a model for a new task or domain requires retraining to perform the new task or perform in the new domain. One mechanism for avoiding this costly retraining is to arithmetically combine parameters of models. For example, arithmetic combination might enable combination of a model trained to recognize one type of animal, such as cats, with a model trained to recognize another type of animal, such as dogs, to result in a model that can recognize both types of animal. Because arithmetic combination does not require retraining, it can substantially reduce the costs (e.g., in time and computing resources) to produce new models. However, naïve arithmetic combination, such as equally weighting the parameters of each model to be combined, can result in negative performance for the combined model. Embodiments of the present disclosure address these issues by providing for efficient determination of coefficients for arithmetic combination of machine learning models, resulting in more efficient creation of models and more performant models from arithmetic model combination

As described herein, arithmetic model combination involves a mathematical combination of parameters from different ML models to produce a new ML model. For example, a given base model may be trained to recognize a wide variety of animals in images. A fine-tuned variation of that model may be more specifically trained to recognize a particular animal, such as a cat. As a result, the weights of the fine-tuned variation may be different from those of the base model, with these differences being mathematically described as a “weight vector”, which is further detailed below. Conceptually, this weight vector can then be viewed as capturing “knowledge” of the fine-tuned variation as to what constitutes the presence of a cat in an image. Using arithmetic model combination, this “knowledge” can be imparted onto other models. For example, the combination of this weight vector with another model may result in a new model that operates similar to the other base model but with an increased capacity to recognize cats. As one illustration, the other model may be a different fine-tuning of the same base model discussed above, such as a fine-tuning to recognize dogs. The arithmetic combination of the dog-recognizing fine-tuned model with the weight vector for cat recognition may result in a model that has increased recognition (relative to the base model) for both dogs and cats. Notably, such combination does not require additional training. As such, arithmetic combination can be significantly more computationally efficient than training-based fine-tuning, and in particular can help to reduce duplicative computation when multiple models are desired with different combinations of learnings. Illustratively, in the above-example, the “knowledge” learned via cat-specific and dog-specific fine-tuning is repurposed in an arithmetic combination of models, rather than requiring additional cat-and-dog-specific fine-tuning, which would duplicate the computational resources used in the prior distinct fine-tunings.

The term weight vector includes other types of vectors, like task vectors and domain vectors. A task vector can be a type of weight vector that is particular to a given task. In general, a task vector may correspond to a model trained and fine-tuned on labeled data. The task vector may represent the direction in which to adjust a model's behavior or focus to perform a particular task. A task vector could correspond to multiple tasks. Multiple tasks arise in situations such as updating a base model with new data produced from various data collection sources. In some instances, a task vector may include multiple task vectors (which may correspond to the multiple tasks). Domain vectors arise when a model is fine-tuned on unlabeled data. A domain vector could represent the features that arise from differences between the base model and the unlabeled data. Thus, as disclosed herein, the term weight vector includes task vectors and domain vectors.

The above example describes use of arithmetic model combination (also referred to as weight vector arithmetic) to achieve “learning via addition”-that is, where one or more weight vectors are added to a given model to increase the performance of the model at a desired task or domain. While the above example describes single-vector addition, multiple-vector addition is also possible. For example, given weight vectors for both a dog- and cat-specific fine tunings of a base model, arithmetic model combination could be used to add together the base model and the weight vectors for both dog- and cat-specific fine tunings (along with any number of weight vectors representing other fine tunings) to result in a model with increased performance on the data associated with each weight vector.

In addition to learning via addition, arithmetic model combination can be used to “forget via negation” (or “subtraction”). As described in more detail below, the addition of an inverted weight vector to (or, equivalently, subtraction of the weight vector from) a given model can cause the model to be less performant on the data associated with the weight vector. In the example above, subtraction of the cat-specific weight vector from the base model may reduce the base model's performance on recognizing cats in images. This can be particularly beneficial for undesirable tasks or domains. Illustratively, a language generation model may be fine-tuned via training to generate undesirable (or “toxic”) language. The weight vector for such fine-tuning can then be subtracted from the base language generation model to result in a model less prone to generate undesirable language.

As yet another example, arithmetic model combination can be used to learn via analogy. Specifically, when there exists tasks or domains that form an analogous combination in the form of “A is to B as C is to D”, arithmetic model combination can be used to transfer the “knowledge” of the A-to-B relationship to a model trained on data related to C, resulting in a new model to perform D. As an illustration, consider an image recognition model trained to recognize cats, and then fine-tuned to recognize kittens. The difference between the base model and the fine-tuning can represent a “kitten-specific” weight vector. This weight vector might then be applied to a dog-recognition model to result, through arithmetic model combination, in a model fine-tuned to recognize puppies (via the analogy “cats are to kittens as dogs are to puppies”). Such combination can be particularly helpful when little or no training data exists with respect to the final target (‘D’), making training-based fine-tuning difficult.

While the above-description relies primarily on examples related to image recognition, arithmetic model combination can be applied to a wide variety of models, including image-based models, video-based models, audio-based models, text-based models and the like, classification models, regression models, generative models, etc. Thus, these examples should not be construed as limiting.

When conducting arithmetic model combination, a scaling term (sometimes denoted as ‘λ’) may be used to modify a strength of influence of a weight vector on a base model. For example, arithmetic model addition may be represented as θ_{new}=θ+λτ, where θ is an input model, θ_{new} is a resulting new model, t is a weight vector, and λ is a scaling coefficient. Proper selection of the scaling coefficient can be important to the performance of the new model. However, many techniques for scaling coefficient selection are computationally intensive.

For example, one approach might be to conduct multiple arithmetic model combinations and test the accuracy of each resulting new model. This approach can be computationally intensive due to the resources required to assess accuracy, particularly in multi-pass models (such as many generative models). Generally, accuracy calculation can involve generating a complete output and then comparing the output to an expected result (e.g., as denoted in a training data set). In a multi-pass model, generating a complete output involves completing multiple forward passes through the model, which are necessarily serial (for example, a later-pass word in a sequence-to-sequence model depends on prior words, a later-pass image in a diffusion model depends on a prior image, etc.). As such, using accuracy as a mechanism for selection of a scaling coefficient can be computationally inefficient.

Embodiments of the present disclosure enable an alternative approach for scaling coefficient selection in arithmetic model combinations, which can be more computationally efficient than the approaches noted above. Specifically, embodiments of the present disclosure can utilize perplexity of resulting new models as a metric by which to measure relative performance of these new models, thereby enabling selection of scaling coefficients that minimizes perplexity. As disclosed herein, perplexity can be used as a proxy metric for accuracy, and thus selection of a scaling coefficient using perplexity can result in a new model with accuracy similar to that of models generated when using accuracy as a metric for selecting a scaling coefficient. However, in contrast to accuracy, perplexity can often be calculated in parallel (as opposed to the serial nature of accuracy calculations noted above), even in multi-pass models. Thus, selection of a scaling coefficient using perplexity can be more computationally efficient than selection of a scaling coefficient using accuracy (e.g., by enabling use of distributed computing resources to reduce selection time).

The above-described features can be better understood with reference to a more in-depth discussion of machine learning techniques. As described above, machine learning often uses with a comprehensive dataset that comprises examples of the phenomenon or problem the model aims to address. In the context of an image classification example, this dataset might include various images, each described by relevant features like color, size, and shape. Additionally, each image instance in the dataset may be associated with a label, indicating a class depending on the type of images.

Features are the distinctive characteristics extracted from the dataset that the machine learning model utilizes to make predictions or classifications. In the image classification example, features might encompass attributes like the red-green-blue (RGB) values representing color, dimensions denoting size, and geometric properties indicating shape. These features can serve as the input variables that the model processes during training and prediction phases.

A model is a mathematical representation of content learned according to a learning algorithm. For example, a model's parameters may be initialized randomly, and the learning algorithm may define how parameters are modified during a training process to minimize a difference between the model's predictions and the actual labels in the training dataset. The choice of the model architecture (e.g., neural networks, decision trees) can depend on the nature of the problem at hand and the characteristics of the data.

Training generally involves exposing the model to a labeled dataset and adjusting the model's parameters iteratively to improve the predictive accuracy. During this phase, the model can make predictions, and the error (or the disparity between predicted and actual values) can be calculated. Optimization algorithms (e.g., gradient descent) can be employed to update the model's parameters, refining its ability to generalize patterns and relationships within the data. After the model is trained (or concurrently with training), the model can be evaluated on a separate set of data that it has not encountered before, sometimes referred to as the testing dataset. Performance metrics, such as accuracy, precision, recall, or F1 score (representing precision and recall), can be employed to assess how well the model generalizes to new, unseen examples. This step can ensure that the model is able to make accurate predictions beyond the data it was trained on. After successful training and evaluation, the model may be capable making predictions on new, previously unseen data. In the image classification example, if presented with an unfamiliar fruit, the model might utilize its learned parameters to predict the appropriate label based on the observed features.

There are various types of machine learning paradigms, including Recurrent Neural Networks, Long Short-Term Memory (LSTM) networks, Gated Recurrent Units, attention-based networks (e.g., transformers-based, including encode/decode networks, encode only networks, decode only networks, etc. Each such model includes parameters, also known as coefficients, that control operation of the model. The term “foundation” model is used to describe a wide-purpose model trained on broad data such that the foundation model can be applied across a wide range of use cases. Foundation models arise from extensive training, which is typically costly in terms of computing resources and time. Moreover, because of their broad applicability, in some cases a foundation model's performance on specific data is insufficiently accurate without further training.

Because foundation models are pre-trained on a massive dataset, they are sometimes not capable of handling specific targeted new data that a user may be interested in. To address this, a model can be modified via training-based finetuning. This is done to adapt the model's knowledge, which was initially acquired from a diverse and extensive dataset during pre-training, to the nuances and requirements of a more specialized application.

Training-based finetuning includes processes during which a base model's parameters are updated with additional training, creating a new version with altered weighting. While this is a comprehensive way to adapt a pre-trained LLM to a new task or domain, it is also resource intensive. Arithmetic model combination provides an alternative and generally less resource intensive finetuning mechanism. Because arithmetic model combination does not require training, such combination can be completed using significantly fewer resources than training-based fine-tuning.

As discussed above, arithmetic model combination in the context of AI refers to a mathematical operation where vectors (arrays of numbers) are combined to result in a new model. In the context of arithmetic model combination, vectors are the learned parameters of the model, represented either as absolute values (in the context of a model vector) or difference values between two models (in the context of weight vectors). Different vectors can represent different learned parameters of the model. For example, one model trained to perform a first task (or on a first domain) might correspond to a vector representing the first task (or first domain), and another model trained to perform a second task (or on second domain) might correspond to a vector representing the second task (or second domain). In some embodiments, the combination may be adjusted using one or more scaling factors, which are used as numerical coefficients assigned to each element in the vectors and represent how strongly each vector influences an outcome vector. Given two or more vectors and their associated scaling coefficients, the arithmetic model combination can involve multiplying each element of the vectors by its corresponding weight and then summing up these products. The result of this operation is a new vector that captures the combined and weighted information from the original vectors. This, in turn, represents a new model. In this manner, the new model occurs without explicit training beyond that used to create the base models.

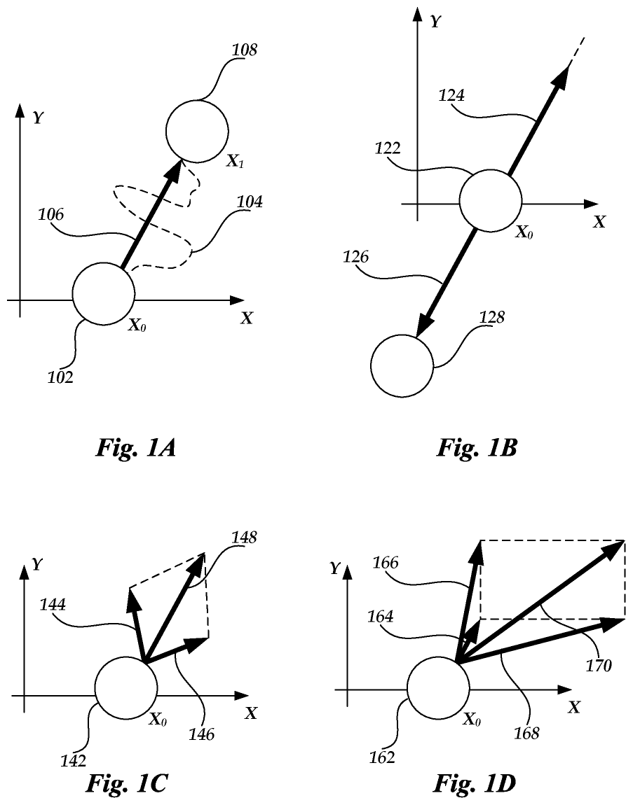

To better describe how arithmetic model combination can be used to generate new models, FIGS. 1A-1D illustrate weight vectors and arithmetic operations for editing ML models. Specifically, FIG. 1A depicts a visual illustration of how a weight vector for a fine-tuned model may be computed, FIG. 1B depicts a visual illustration of how weight vector arithmetic can be used to aid in forgetting in a trained model, FIG. 1C depicts a visual illustration of how arithmetic can be used to combine weight vectors from multiple fine tunings to result in a model that adopts learnings from the fine-tunings, and FIG. 1D depicts a visual illustration of how weight vector arithmetic can be used to generate new models when fine tunings form an analogy relationship. As used herein, the term “ML model” encompasses a wide variety of types of model, including but not limited to generative models, classification models, and regression models. Such models can include a variety of architectures, including neural networks, diffusion models, and transformer-based models (encoder/decoder, encode only, or decode only), and recurrent neural networks, among others. Such models can be applied to a variety of uses, such as computer vision, image or video generation, or text generation (e.g., via sequence-to-sequence modeling). In one embodiment, an ML model is a large language model (LLMs), where large is indicative of a number of parameters in the trained model, e.g., 500 MM+, 7 B+, 40 B+, etc. As will be appreciated by one skilled in the art, training for many models, and particularly large language models, foundation models, or other similarly complex models, can be computationally intensive and time consuming. Thus, embodiments for fine tuning such models without retraining, such as those described herein, can be particularly beneficial for complex models.

In FIG. 1A, model parameters are represented as locations on a two-dimensional plane. For example, a first model parameter can be represented by a location on the X-axis, and a second model parameter can be represented by a location on the Y-axis. While FIGS. 1A-D depict locations in a two-dimensions for simplicity, in practice the number of parameters of a model can be extremely large (in the millions, billions, trillions or more). Thus, the parameters of the model could be conceptually represented in an n-dimensional space, where n is the number of parameters of the model. Accordingly, locations and vectors as described herein may be of very high dimensionality.

In FIG. 1A, a pretrained model 102 is depicted in FIG. 1A as located at a first position (denoted as X₀). A fine-tuned model 108, representing a fine-tuning of the model 102, is located at a second position (denoted X₁). The model shift 104 can represent the changes to the pretrained model 102 to arrive at the fine-tuned model 108. For example, training the pretrained model 102 on a new task or domain can change parameters of the pretrained model 102 to result in parameters at the location corresponding to the fine-tuned model 108. The incremental changes can be visually illustrated as a dimensional change (e.g., the winding curves of the model shift 104).

The difference between the pretrained model 102 and the fine-tuned model 108 is represented by weight vector 106, which is the per-dimension variance in the parameter values of the two models 102 and 108. The weight vector 106 is given by the element-wise difference (where each element is visually depicted as a dimension in FIGS. 1A-1D and represents a parameter) between the fine-tuned model 108 and the pretrained model 102.

One use of weight vectors, as calculated according to the above-described methodology, is to enable “forgetting.” In certain instances, a model may learn undesirable information. For example, a language generation model may learn to generate undesirable (e.g., toxic) language. “Forgetting” is thus a mechanism to remove, at least to some extent, this behavior from the model, resulting a model less likely to generate the undesirable content. FIG. 1B illustrates an example of how weight vector arithmetic can aide in forgetting. Specifically, FIG. 1B illustrates how a weight vector 124 can be subtracted from a base model 122 to result in a new location, corresponding to parameters of a new model that has “forgotten” the information of the weight vector, as illustrated in a new model 128. Specifically, the weight vector 124 can be calculated by fine tuning the base model 122 to learn information later to be removed from the base model 122, such as by training the base model 122 to produce toxic language. Illustratively, this information may be already present in the base model 122, and be emphasized by fine tuning. Vector arithmetic can then be used to subtract the weight vector 124 from the base model 122 (along vector 126, representing the inverse of the weight vector 124) to arrive at a new location, representing parameters of a new model that attempts to “forget” the learnings of the fine-tuned model. As a result, the new model can have less ability to generate the undesirable content.

In certain instances, a user may desire a model to perform multiple new tasks or in multiple new domains. Each new task or domain may correspond to a dataset different than the data on which the base ML model trained. For example, a user may be interested in having the base ML model, not pretrained with finance domain data, provide question answering on tabular and text content and assessment of financial news sentiment analysis. Each of the desired new tasks or domains can be in the form of a separate vector representing a change from a base ML model to a new ML model. FIG. 1C illustrates how a resultant weight vector 148 may form from adding multiple new tasks or domains. Adding weight vectors together may increase performance of the base ML model on the tasks or domains under consideration. In some examples, the multi-weighted model 142 provides increased performance over models fine-tuned on individual tasks. Adding weight vectors can be used to build multi-weighted models that are proficient on multiple tasks or domains simultaneously or to improve single-weighted performance. In particular, the resultant weight vector 148 may result from mathematical combination of weight vectors 144 and 146, each represent a separate fine-tuning of the model 142. When added to the multi-weighted model 142, weight vector 148 results in a new model combining functionality of the multi-weighted model 142 with individual weight vectors 144 and 146. In this manner, the additive operation can result in finetuning without additional training or access to training data.

Another use of weight vectors, as calculated according to the methodology described herein, is to form an analogy relationship. Analogies are combinations of weight vectors resulting in a model that can improve performance on a target task or domain, such as one that has sparse or unlabeled data. As an example, an analogy relationship may form by combining weight vectors to improve performance on a new weight vector. In this example, a subset of the combined weight vectors may have a relationship, such that the new ML model might better perform on the new task or domain because the new task or domain may relate to at least one of the combined weight vectors. The performance may increase for the new ML model even when little or no training data is available for the new task or domain. FIG. 1D illustrates an example of how a target weight vector 170 may form from an analogy relationship. Specifically, the target weight vector 170 may form by fine tuning a base model 162 with respect to a first weight vector 164, a second weight vector 166, and a third weight vector 168. In this example, the first weight vector 164 relates to the second weight vector 166 in a manner that provides context to a new ML model to perform on the target weight vector 170. The relationship between the first weight vector 164 and the second weight vector 166 gives context to the new ML model about a relationship between the third weight vector 168 and the target weight vector 170. Having this analogy relationship, the new ML model can perform the target weight vector 170 with improved performance.

When performing the arithmetic operations as disclosed in FIGS. 1A-1D, there may be a risk that a new ML model performs worse on control data than a base ML model, this is known as regression. Regression may negatively impact the model in terms of human alignment with desired action because of the new ML model's poorer performance on the control data. The control data include data used during training of the base ML model, and may relate to general purpose operations, so the base ML model performs well on the control data. Selection of an appropriate scaling coefficient can minimize regression by controlling how much a weight vector modifies the base ML model from vector arithmetic. Controlling how much the weight vector modifies the base ML model results in a new ML model that is more closely aligned with the base ML model. The new ML model being more closely aligned with the base ML model results in the new ML model performing better on the control data. Depending on its value, the scaling coefficient A controls how much the new ML model might operate like a fine-tuned ML model (corresponding to the weight vector) or the base ML model. The scaling coefficient can be a value from the range [0,1]. When the scaling coefficient is 0, the new ML model may be the same as the base ML model. When the scaling coefficient is 1, the new ML model may be the same as the fine-tuned ML model (less like the base ML model). Embodiments disclosed herein enable more efficient selection of scaling coefficients. Thus, embodiments enable better generation of ML models that avoid regression.

Evaluating performance of a new ML model provides insight on the choice of coefficients because performance of the new ML model depends heavily on the coefficients. One approach to measuring the performance of different coefficients for the new ML model is to evaluate performance metrics by testing the new ML model on a dataset with the different coefficients. Some methods of evaluating performance metrics involve measuring accuracy of the new ML model. Measuring accuracy of the new ML model can involve testing on a validation dataset, where different combinations of the scaling coefficient provide varying levels of accuracy. However, accuracy calculation can involve generating a complete output and then comparing the output to an expected result (e.g., as denoted in a training data set). In a multi-pass model, generating a complete output involves completing multiple forward passes through the model, which are necessarily serial (for example, a later-pass word in a sequence-to-sequence model depends on prior words, a later-pass image in a diffusion model depends on a prior image, etc.). As such, using accuracy as a mechanism for selection of a scaling coefficient can be computationally inefficient. The methods disclosed herein provide an approach to select a scaling coefficient based on performance of models with different scaling coefficients as measured using perplexity as a metric.

As described herein, perplexity is a measure of a model's uncertainty. In LLMs, for example, the model predicts a next word in a sequence of words. Uncertainty is a measure of how well the model can predict the next word in the sequence from the preceding word's context. So, for example, if an LLM is predicting a next word for a sentence of zoo animals (“tiger,” “lion,” “bear,” etc.), and the LLM predicts the next animal is a type of car, the uncertainty of the LLM would be high. Because perplexity is the measure of uncertainty, the perplexity in this example would also be high.

Accuracy, on the other hand, is often computed as the ratio of correct predictions to the total number of predictions. For LLMs, measuring accuracy might include comparing a model's generated text with a reference (such as a correct output expected from the model). So, when a user requests the LLM to perform a new task or in a new domain, accuracy is measured by how well the output compares to the output the user would expect for the new task or domain. If the user is seeking a model performing better than the other LLMs, then multiple LLMs may be tested and the user might compare the outputs of each LLM. This is a serial computation because the user runs each LLM to completion to produce the output.

Perplexity and accuracy are correlated, such that one may avoid the serial calculation of accuracy and efficiently select a scaling coefficient using perplexity. For example, to compare performance between LLMs and identify which LLM performs better than others, the user may choose to calculate perplexity or accuracy for comparison. On one hand, the user may compute the perplexities of a number of LLMs in parallel and assess the perplexities to find the LLM with the lowest perplexity. On the other hand, the user may compute the accuracy of a number of LLMs by generating outputs of the models for comparison.

As noted above, arithmetic model combination involves combining information associated with two or more models, such as by according to scaling coefficients that control how influential the weights of each model are to the combined model. In accordance with embodiments of the present disclosure, scaling coefficients may be selected based on the new model's performance on data associated with any combined models. For example, when combining a general base model with a weight vector for a specific task or domain, a scaling coefficient may be selected based on the new model's performance at the specific task or domain (e.g., to maximize performance at the task), based on the new model's performance at the general task or domain (e.g., to minimize regression), or a combination thereof.

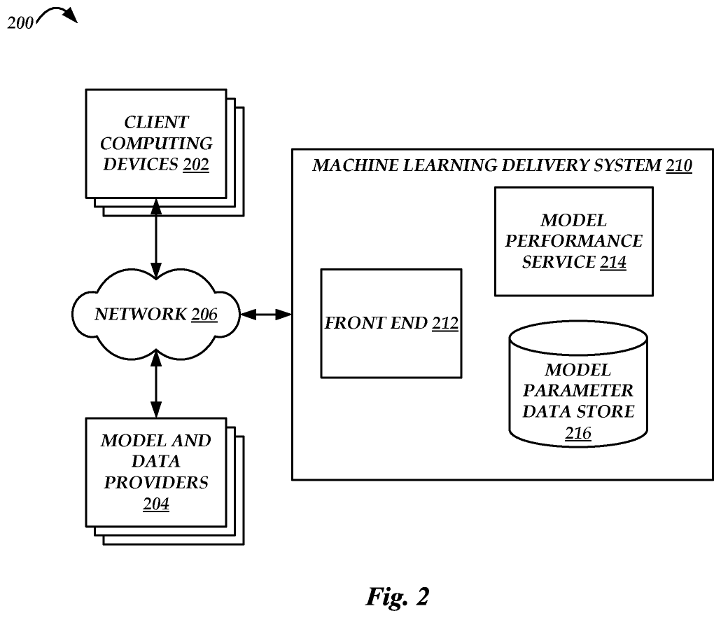

FIG. 2 is a block diagram of an example operating environment 200 in which a machine learning delivery system 210 may operate to compute coefficients for model vector arithmetic in order to provide machine learning models to client computing devices 202. In general, the client computing devices 202 may be any computing device such as a desktop, laptop or tablet computer, personal computer, wearable computer, server, personal digital assistant (PDA), hybrid PDA/mobile phone, mobile phone, electronic book reader, set-top box, voice command device, camera, digital media player, and the like.

The illustrative environment 200 further includes one or more model and data providers 204, which are configured to provide models and data to the client computing devices 202 and the machine learning delivery system 210. In some examples, the model and data providers 204 may train a base ML model and provide the base ML model to the client computing devices 202 and the machine learning delivery system 210. The one or more model and data providers 204 may be commercial or private entities providing models and data. In accordance with embodiments of the present disclosure, model and data providers 204 may provide ML models that enable arithmetic model combination. For example, a first model and data provider 204 may provide a base model and a second model and data provider 204 may provide a fine-tuning of the base model, which two models (and potentially additional models) can be combined via arithmetic combination to result in a new model.

The client computing devices 202 and model and data providers 204 may communicate with the machine learning delivery system 210 via a network 206, which may include any wired network, wireless network, or combination thereof. For example, the network 206 may be a personal area network, local area network, wide area network, over-the-air broadcast network (e.g., for radio or television), cable network, satellite network, cellular telephone network, or combination thereof. As a further example, the network 206 may be a publicly accessible network of linked networks, possibly operated by various distinct parties, such as the Internet. In some embodiments, the network 206 may be a private or semi-private network, such as a corporate or university intranet. The network 206 may include one or more wireless networks, such as a Global System for Mobile Communications (GSM) network, a Code Division Multiple Access (CDMA) network, a Long Term Evolution (LTE) network, or any other type of wireless network. The network 206 can use protocols and components for communicating via the Internet or any of the other aforementioned types of networks. For example, the protocols used by the network 206 may include Hypertext Transfer Protocol (HTTP), HTTP Secure (HTTPS), Message Queue Telemetry Transport (MQTT), Constrained Application Protocol (CoAP), and the like. Protocols and components for communicating via the Internet or any of the other aforementioned types of communication networks are well known to those skilled in the art and, thus, are not described in more detail herein.

The machine learning delivery system 210 can include a variety of components and devices configured to enable the client computing devices 202 to obtain new ML models generated by the machine learning delivery system 210. For example, the machine learning delivery system 210 may include a front end 212, a model performance service 214, and a model parameter data store 216. In an illustrative embodiment, the front end 212 serves as a “front door” to the other services provided by the machine learning delivery system 210, enabling users (via client computing devices 202) to interact with ML models. In one embodiment, the front end 212 may communicate with external computing devices (e.g., client computing devices 202, etc.) via a graphical user interface (GUI), command line interface (CLI), or application programming interface (API).

The machine learning delivery system 210 may include a model performance service 214 configured to efficiently determine coefficients for vector arithmetic. To efficiently determine the coefficients for vector arithmetic, the model performance service 214 may generate a plurality of new models by arithmetic combination of the base ML model and a weight vector. The model performance service 214 assigns a different scaling coefficient for each of the plurality of new models. The model performance service 214 may compute perplexities for each of the plurality of new models using parallelized forward passes. The perplexity values for an individual new model are calculated according to a validation data set. The validation data set may include data corresponding to the base ML model and data corresponding to a fine-tuned ML model. The model performance service 214 may select a scaling coefficient based on the perplexity values for one of the plurality of new models. The scaling coefficient is selected based on performance of the new model relative to both the base ML model and the fine-tuned ML model.

The model parameter data store 216, which may be utilized to store models (e.g., both models resulting from training and models resulting from vector arithmetic), weight vectors, and weight vectors can correspond to any persistent or substantially persistent data storage, such as a hard drive (HDD), a solid state drive (SDD), network attached storage (NAS), a tape drive, database, storage service, or other device or service, or any combination thereof. In one embodiment, weight vectors are stored within the model parameter data store 216 as LoRA-style decomposed matrices. Low-rank adaptation (LoRA) is a mechanism by which a set of weight differences (also called deltas) are decomposed into two decomposed matrices with low rank dimensions. This decomposition enables the weight differences to be stored efficiently, using less storage space than the non-decomposed weight differences. As weight vectors discussed herein represent weight differences, storage of weight vectors in a LoRA-style set of decomposed matrices can provide an efficient storage mechanism. In some embodiments, the machine learning performance service 214 is configured to calculate weight vectors as a set of weight differences, and then to decompose the weight vector into a LoRA-style set of decomposed matrices for storage. In other embodiments, weight vectors may be obtained as a LoRA-style set of decomposed matrices (e.g., from the model and data providers 204). In some instances, a given model may be stored as a base model and weight vector pair, such that the given model is constructed from combination of the base model and weight vector pair on demand or in response to a request for the given model. In this manner, a wide variety of models can be stored efficiently, as different variations of a model may be stored as a base model and multiple weight vectors, resulting in storage without significant duplication in stored information.

The machine learning delivery system 210 is depicted as operating in a distributed computing environment including several computer systems that are interconnected using one or more computer networks (not shown in FIG. 2). The machine learning delivery system 210 could also operate within a computing environment having a fewer or greater number of devices than are illustrated in FIG. 2. Thus, the depiction of the machine learning delivery system 210 in FIG. 2 should be taken as illustrative and not limiting to the present disclosure. For example, the machine learning delivery system 210 or various constituents thereof could implement various Web services components, hosted or “cloud” computing environments, and/or peer to peer network configurations to implement at least a portion of the processes described herein.

Further, the machine learning delivery system 210 may be implemented directly in hardware or software executed by hardware devices and may, for instance, include one or more physical or virtual servers implemented on physical computer hardware configured to execute computer executable instructions for performing various features that will be described herein. The one or more servers may be geographically dispersed or geographically co-located, for instance, in one or more data centers. In some instances, the one or more servers may operate as part of a system of rapidly provisioned and released computing resources, often referred to as a “cloud computing environment.”

It will be appreciated by those skilled in the art that the machine learning delivery system 210 may have fewer or greater components than are illustrated in FIG. 2. In addition, the machine learning delivery system 210 could include various web services and/or peer-to-peer network configurations. Thus, the depiction of the machine learning delivery system 210 in FIG. 2 should be taken as illustrative. For example, in some embodiments, components of the machine learning delivery system 210, such as the model performance service 214, may be executed by one or more virtual machines implemented in a hosted computing environment. A hosted computing environment may include one or more rapidly provisioned and released computing resources, which computing resources may include computing, networking and/or storage devices. A hosted computing environment may also be referred to as a cloud computing environment.

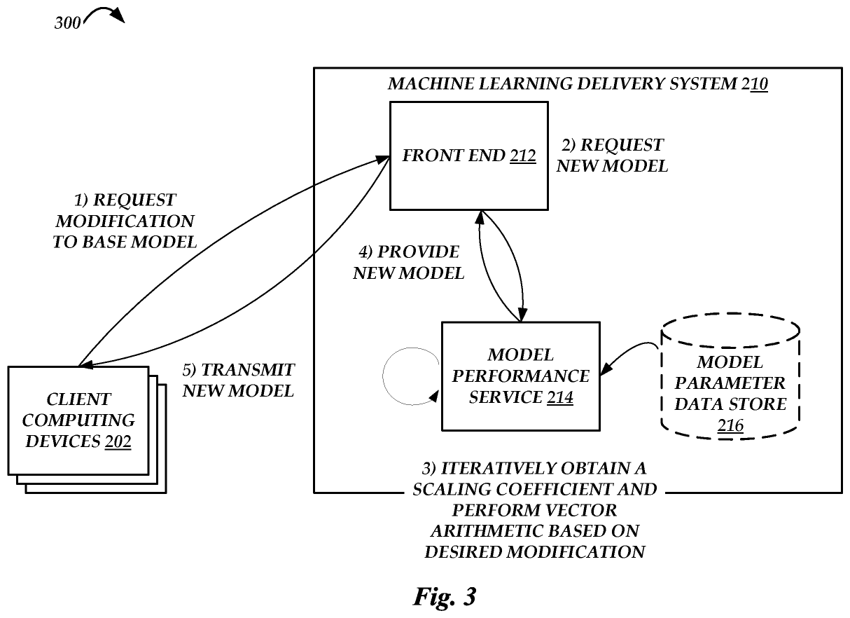

FIG. 3 illustrates a flow diagram 300 depicting example interactions for efficiently selecting a scaling coefficient by using perplexity to assess performance. As discussed above, the example interactions may allow an ML model delivery environment to support faster and more efficient execution of determining coefficients for vector arithmetic. With reference now to FIG. 3, at (1), a client computing device 202 sends a request to modify a base ML model to a front end 212 of the machine learning delivery system 210. The request may be generated by a client's use of the client computing devices 202, such as by launching or interacting with an application for developing ML models. The request may indicate at least the base ML model and a desired modification by the client. The desired modification may correspond with subtraction of one or more weight vectors (e.g., to modify the base model to reduce performance at an undesirable task or domain) or addition of one or more weight vectors (e.g., to modify the base model to increase performance and desired tasks or domains), where analogies are a special case of addition or subtraction. For example, the user may desire for the base ML model to forget undesirable information (subtraction).

At (2), the front end 212 passes the request for the modification of the base ML model to the model performance service 214. The front end 212 may, in some embodiments, request a new ML model from the model performance service 214. For example, the front end 212 may provide an identifying name of the base ML model and the desired modification to the model performance service 214. In this manner, the model performance service 214 can reference the model parameter data store 216 to obtain the base ML model.

At (3), the model performance service 214 is configured to efficiently determine coefficients for vector arithmetic. In some instances, the model performance service 214 may obtain one or more weight vectors, each corresponding to a desired modification to the base model. The model performance service 214 may compute the weight vector by finding the difference between the base ML model and a fine-tuned ML model. The weight vector may be used to combine with the base ML model to achieve the desired modification. In some instances, the weight vector combines with the base ML model via addition or subtraction (inversion). In some instances, the model performance service 214 may optionally send the weight vector to the model parameter data store 216 for storing. In some instances, the weight vector is stored as two decomposed LoRA matrices and the model performance service 214 may obtain the weight vector directly.

The model performance service 214 can be configured to generate a plurality of ML models from a result of arithmetic operations applied to the base ML model. The arithmetic operations may include combining, the base ML model, the weight vector, and a scaling coefficient. The scaling coefficient may control how influential the base ML model and each of the plurality of ML models are to resulting models. The model performance service 214 may generate the plurality of ML models using different values of the scaling coefficient for each ML model, such that each of the ML models may behave differently. For example, the values of the scaling coefficients may be one value in a range [0,1]. In some instances, when multiple task vectors exist, the model performance service 214 may compute a multi-vector scaling coefficient to apply for each of the multiple task vectors. The multi-vector scaling coefficient may be a weighted average of the scaling coefficients for the weight vectors. Having different scaling coefficients for each of the ML models provides a framework to generate the plurality of ML models. While combination is described above with respect to a weight vector, in some embodiments multiple weight vectors may be combined with a base model. Each such vector may be associated with a scaling coefficient calculated according to the techniques described herein.

The model performance service 214 may compute perplexity values for each of the plurality of ML models. The perplexity values for each of the plurality of ML models are calculated according to each ML model's performance on a validation data set that illustratively includes, data corresponding to the base ML model, data corresponding to the fine-tuned ML model, or a combination thereof. The validation data set may be used as a reference as compared to outputs from each of the plurality of ML models. The model performance service 214 computes the perplexity values using parallelized forward passes. Measuring perplexity values for the plurality of the ML models may reflect on each model's degree of uncertainty when tested with the validation data set. Thus, computing the perplexity, in this manner, monitors each model's ability to perform on data with respect to the fine-tuned ML model and with respect to the base ML model.

The model performance service 214 may select one of the values of the scaling coefficients based on the perplexity values for the plurality of ML models. In some instances, the model performance service 214 selects one of the values based on a ML model's performance relative to both the base ML model and the fine-tuned ML model. The ML model's perplexity may be within a threshold with respect to performance of the base ML model. In some instances, the model performance service 214 may select the scaling coefficient that leads to one of the plurality of ML models having a perplexity value within the threshold.

The model performance service 214 may generate a new ML model by combining the base ML model, the weight vector, and the scaling coefficient using vector arithmetic. In some instances, the model performance service 214 may verify that accuracy of the new ML model satisfied a threshold value prior to returning the new ML model in response to the request. The model performance service 214 may verify accuracy of the new ML model with the validation data set.

At (4), the model performance service 214 provides the new ML model to the front end 212. For example, the model performance service 214 can be configured to transmit the new ML model in response to the request from the front end 212. The request may be generated by a client's use of the client computing devices 202, such as by launching or interacting with an application for developing ML models. The request may indicate at least the base ML model and a desired modification by the client.

At (5), the front end 212 transmits the new ML model to the client computing devices 202. For example, the front end 212 can be configured to transmit the new ML model in response to the request from the client computing devices 202. It will be understood that FIG. 3 is provided for purposes of example, and that many variations on the depicted interactions are within the scope of the present disclosure. For example, the interactions at (3) may be carried out in parallel with the interactions at (1) and (2). The interactions disclosed herein may be optional. Additionally, there may be interactions not illustrated that provide additional functionality. As a further example, the model performance service 214 may generate the new ML model upon receiving the request at (1). FIG. 3 is thus understood to be illustrative and not limiting.

While combination is described above with respect to an individual weight vector, in some embodiments multiple weight vectors may be combined with a base model. Multiple weight vectors may correspond with various requests from the user to modify a base ML model. For example, a user may request an update to the base ML model to include data for new animals from a plurality of different datasets. The different datasets may correspond to multiple different weight vectors.

One potential difficulty with the use of multiple weight vectors in arithmetic model combination is determination of an appropriate scaling coefficient for each weight vector. A general approach may be to generate models for a variety of coefficient combinations, and then to assess the performance of the resulting models (e.g., according to accuracy, perplexity, or other metrics). However, this approach can be computationally intensive, particularly for large numbers of weight vectors. For example, the combination of a base model and n weight vectors may require a grid search over an n dimensional space, with each dimension representing a value for a scaling coefficient of the nth vector. Accordingly, the number of models to be evaluated under such an approach can quickly grow to prohibitive levels.

To address this, embodiment of the present disclosure can calculate scaling coefficients for individual weight vectors, intended for combination in aggregate with a given base model, individually. Such embodiments may then combine the base model with the multiple vectors, applying the scaling coefficient for each weight vector to that weight vector, and optionally applying an aggregate scaling coefficient to the sum of all such weight vectors. As a result, each determination may occur linearly (e.g., on a scale of 0 to 1 for each coefficient). Thus, such embodiments can avoid the combinatorial explosion noted above when coefficients are determined jointly.

Specifically, when combining a base multiple with multiple weight vectors, a model performance service 214 as disclosed herein may determine a scaling coefficient for combination of the base model with each weight vector individually, in the manner described above.

The model performance service 214 may then determine a consolidated weight vector by computing a weighted average with respect to each of the multiple weight vectors and their respective selected scaling coefficients. The weighted average may result from summing a combination of the multiple weight vectors and their respective selected scaling coefficient and then dividing by a number of the multiple weight vectors.

In some instances, the consolidated weight vector may have increased or decreased regression, which may be undesirable. To address this, in some embodiments an additional aggregate scaling coefficient may be applied to the consolidated weight vector prior to combination with the base model. The model performance service 214 may compute the consolidated scaling coefficient in a manner similar to calculation of a coefficient for a single weight vector, as disclosed herein. For example, in some instances, the model performance service 214 may generate a plurality of ML models for the consolidated weight vector from a result of arithmetic operations applied to the base ML model. The arithmetic operations may include combining, the base ML model, the consolidated weight vector, and a range of values for the consolidated scaling coefficient. The model performance service 214 may compute perplexity values for the plurality of ML models. In some instances, the model performance service 214 may select one of the values of the consolidated scaling coefficients based on the perplexity values for the plurality of ML models.

Once the consolidated weight vector, and optionally the consolidated scaling coefficient, have been determined, the model performance service 214 may generate a new ML model by arithmetic combination of the base model with the consolidated weight vector, and optionally the consolidated scaling coefficient. The model performance service 214 may thereafter implement further operations with respect to the generated model, as disclosed herein.

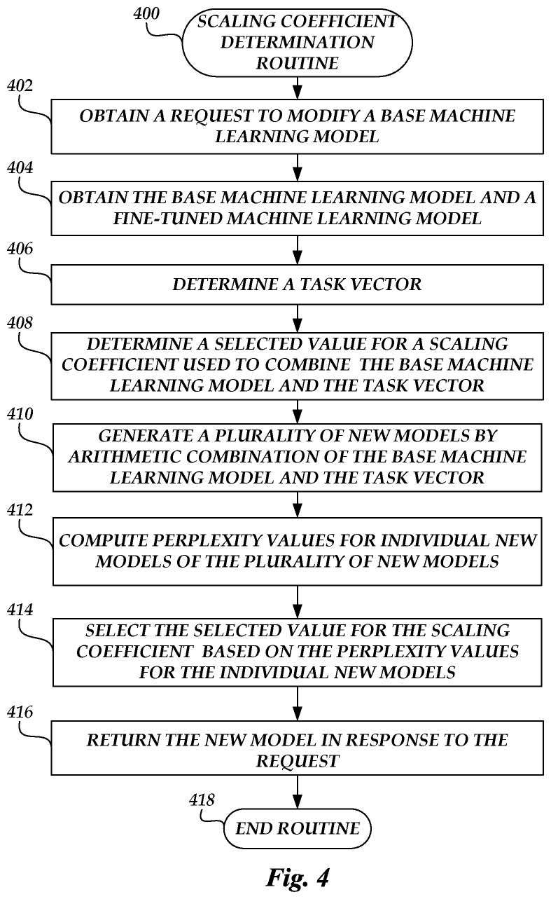

FIG. 4 is one illustrative routine 400 for efficiently determining a scaling coefficient. The routine 400 may be carried out, for example, by the model performance service 214 of FIG. 2. The routine 400 begins at block 402, where the model performance service 214 obtains a request to modify a base ML model. For example, the user may request additional capabilities to perform financial question answering on tabular and text content by requesting the base ML model add a financial dataset to its knowledge base. In one embodiment, the request directly specifies one or more of the base model and a source of modification of the base model (e.g., a specific fine-tuned model or weight vector). In another embodiment, the request may illustratively specify tasks or domains corresponding to one or both of the base model and desired modification of the base model. For example, the request may specify that the desired modification is an image-recognition model (which may be otherwise unspecified, aside from categorization as a model that conducts image recognition) modified to have increased recognition of a particular object type.

At block 404, the model performance service 214 obtains a base ML model and a fine-tuned ML model corresponding to the desired modification. The model performance service 214 may obtain the base ML model from sources, such as the model and data providers 204 (as illustrated in FIG. 2). In some instances, the model and data providers 204 may be commercial model and data providers, or even open-source repositories for ML development. In some instances, the model performance service 214 may generate the fine-tuned ML model by fine tuning the base ML model. In some cases, such as in the case when the desired modification includes an analogy, the fine-tuned ML model may generate the fine-tuned ML model by fine tuning a different model. In the instance that the request specifies tasks or domains for one or more of the base model or the source of modification of the base model, rather than directly specifying such base model or source, the model performance service 214 may identify the base model or source according to information stored at the model performance service 214. For example, models and weight vectors of the model performance service 214 may be stored with metadata denoting tasks or domains associated with the models or vectors, which the model performance service 214 may utilize to select a model or vector appropriate to the request, such as by selecting a model with metadata denoting it as capable of performing image-recognition when the request specifies an image-recognition task or domain.

At block 406, the model performance service 214 determines the weight vector. The weight vector may represent a difference between the base ML model and the fine-tuned ML model. In some instances, the model performance service 214 may compute the weight vector by finding the difference between the base ML model and the fine-tuned ML model. In some instances, the weight vector may correspond with the desired modification to the base ML model. The fine-tuned ML model may correspond with multiple weight vectors when the desired modification requests proficiency on multiple tasks or domains. In some instances, multiple weight vectors may be determined. For example, a request may specify multiple additional tasks or domains desired for a new model, each of which corresponds to a different weight vector. For example, multiple tasks or domains may arise when updating a base model with new data produced from continuous data collection sources. In some instances, the multiple tasks or domains may correspond with multiple weight vectors. In some instances, rather than calculating a weight vector, the weight vector may be pre-computed (e.g., stored within the model data store 216). Accordingly, block 406 may be omitted, and block 404 may be modified to obtain the pre-computed weight vector, rather than a fine-tuning.

The desired modification to the base ML model may lead to vector arithmetic by combining the base ML model and the weight vector. In some cases, the weight vector combines with the base ML model via addition and/or subtraction. When the desired modification includes subtraction as part of the vector arithmetic, the weight vector may be an inversion, such that aspects of the weight vector are subtracted from the base model. In some instances, the weight vector may be stored by the model parameters data store 216. In some instances, the weight vector may be stored as two decomposed LoRA matrices. The model performance service 214 may obtain the weight vector directly when the weight vector is stored as two decomposed LoRA matrices.

At block 408, the model performance service 214 determines a selected value for a scaling coefficient used to combine the base machine learning model and the weight vector. In some instances, the scaling coefficient indicates a weight to be applied to the weight vector during weight vector arithmetic. The model performance service 214 determines the selected value for the scaling coefficient according to the steps in blocks 410-414.

At block 410, the model performance service 214 generates a plurality of new models by arithmetic combination of the base ML model and the weight vector. The model performance service 214 may generate the plurality of ML models using different values of the scaling coefficient for each ML model, such that each of the ML models may behave differently. For example, the values of the scaling coefficients may be one value in a range [0,1]. Having different scaling coefficients for each of the ML models provides a framework to generate the plurality of ML models.

At block 412, the model performance service 214 computes perplexity values for individual new models of the plurality of new models. The model performance service 214 computes the perplexity values for the individual new models using parallelized forward passes. The perplexity values for an individual new model are calculated according to a validation data set including both data corresponding to the base ML model and data corresponding to the fine-tuned ML model. The validation data set may be used as a reference to compare outputs from each of the plurality of new models.

At block 414, the model performance service 214 selects the selected value for the scaling coefficient based on the perplexity values for the individual new models. In some instances, the selected value corresponds to a first new model, of the plurality of new models, generated according to the selected scaling coefficient. The selected value may be selected based on performance of the first new model relative to both the base ML model and the fine-tuned ML model.

While the above description relates to determination of a single coefficient for a single weight vector, the routine 400 in some instances may be modified to determine multiple coefficients for multiple weight vectors, each coefficient controlling a strength of impact on a corresponding weight vector with respect to a generated new model. For example, block 410 may be modified to generate models with varying values for each of the multiple coefficients, which then may be evaluated according to blocks 412 and 414.

At block 416, the model performance service 214 returns a new model in response to the request. For example, the service 214 may identify the particular new model, of those generated at block 410, corresponding to the selected scaling coefficient value, and return the particular new model in response to the request. In some instances, the model performance service 214 may return the new model to the user via the front end 212.

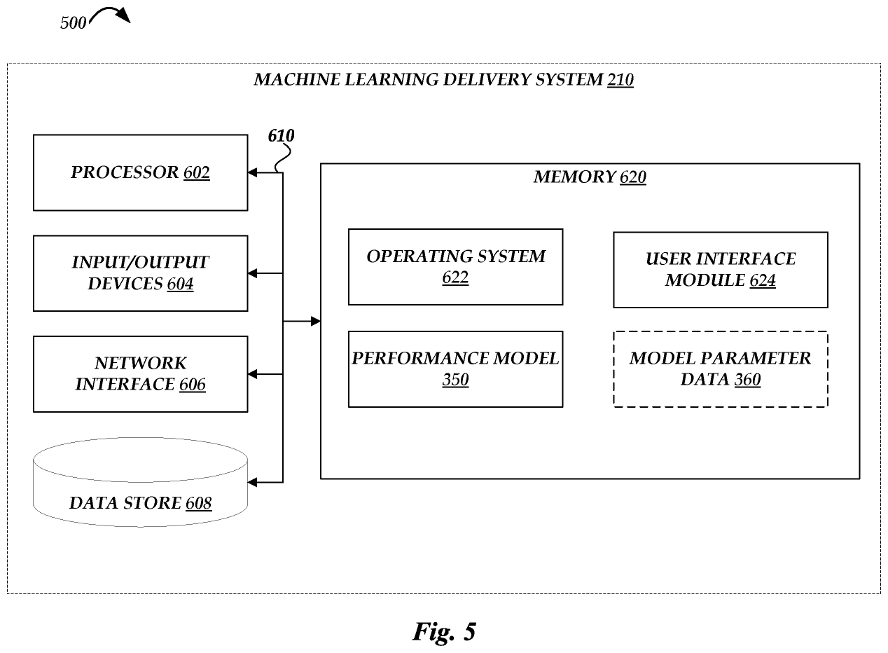

FIG. 5 depicts a general architecture 500 of a computing system (referenced as machine learning delivery system 210) that operates to generate new ML models and efficiently determine coefficients of the ML models within the machine learning delivery system 210. The general architecture of the machine learning delivery system 210 depicted in FIG. 5 includes an arrangement of computer hardware and software modules that may be used to implement aspects of the present disclosure. The hardware modules may be implemented with physical electronic devices, as discussed in greater detail below. The machine learning delivery system 210 may include many more (or fewer) elements than those shown in FIG. 5. It is not necessary, however, that all of these generally conventional elements be shown in order to provide an enabling disclosure. Additionally, the general architecture illustrated in FIG. 5 may be used to implement one or more of the other components illustrated in FIG. 2. As illustrated, the machine learning delivery system 210 includes a processor 602, input/output device interfaces 604, a network interface 606, and a data store 608, all of which may communicate with one another by way of a communication bus 610. The network interface 606 may provide connectivity to one or more networks or computing systems, such as client computing devices 202, model and data providers 204, or other components of the environment 200. The processor 602 may thus receive information and instructions from other computing systems or services via the network 206. The processor 602 may also communicate to and from a memory 620 and further provide output information for an optional display (not shown) via the input/output device interfaces 604. The input/output device interfaces 604 may also accept input from an optional input device (not shown).

The memory 620 may contain computer program instructions (grouped as modules in some embodiments) that the processor 602 executes in order to implement one or more aspects of the present disclosure. The memory 620 generally includes random access memory (RAM), read only memory (ROM) and/or other persistent, auxiliary or non-transitory computer readable media. The memory 620 may store an operating system 622 that provides computer program instructions for use by the processor 602 in the general administration and operation of the machine learning delivery system 210. The memory 620 may further include computer program instructions and other information for implementing aspects of the present disclosure. For example, in one embodiment, the memory 620 includes an interface module 624 that generates interfaces (and/or instructions therefor) for interacting with the front end 212, or other computing devices, e.g., via an API, CLI, and/or Web interface. In addition, the memory 620 may include and/or communicate with one or more data repositories (not shown), for example, to access user program codes and/or libraries.

In addition to and/or in combination with the user interface module 624, the memory 620 may include a performance model 350 that may be executed by the processor 602. In one embodiment, the performance model 350 implements various aspects of the present disclosure, e.g., finetuning ML models, generating new ML models, and efficiently determining coefficients for the ML models, as described herein. While the performance model 350 is shown in FIG. 5 as part of the machine learning delivery system 210, in other embodiments, all or a portion of the performance model 350 may be implemented by other components of the machine learning delivery system 210 and/or another computing device. For example, in certain embodiments of the present disclosure, another computing device in communication with the machine learning delivery system 210 may include several modules or components that operate similarly to the modules and components illustrated as part of the machine learning delivery system 210.

The memory 620 may further include model parameter data 360, which may be loaded into memory in conjunction with finetuning the ML models, generating new ML models, and efficiently determining coefficients for the ML models for the machine learning delivery system 210. In some embodiments, the memory 620 may further include, e.g., information regarding particular host computing devices or virtual machine instances, particular requests to execute child tasks, or other information that is used to finetune, generate, and efficiently determine coefficients for ML models.

In some embodiments, the machine learning delivery system 210 may further include components other than those illustrated in FIG. 5. For example, the memory 620 may further include information regarding performance characteristics, original parameters for a base ML model, or other information that facilitates finetuning ML models, generating new ML models, and efficiently determining coefficients for the ML models. FIG. 5 is thus understood to be illustrative but not limiting.

It is to be understood that not necessarily all objects or advantages may be achieved in accordance with any particular embodiment described herein. Thus, for example, those skilled in the art will recognize that certain embodiments may be configured to operate in a manner that achieves or optimizes one advantage or group of advantages as taught herein without necessarily achieving other objects or advantages as may be taught or suggested herein.

All of the processes described herein may be embodied in, and fully automated via, software code modules, including one or more specific computer-executable instructions, which are executed by a computing system. The computing system may include one or more computers or processors. The code modules may be stored in any type of non-transitory computer-readable medium or other computer storage device. Some or all the methods may be embodied in specialized computer hardware.

Many other variations than those described herein will be apparent from this disclosure. For example, depending on the embodiment, certain acts, events, or functions of any of the algorithms described herein can be performed in a different sequence, can be added, merged, or left out altogether (e.g., not all described acts or events are necessary for the practice of the algorithms). Moreover, in certain embodiments, acts or events can be performed concurrently, e.g., through multi-threaded processing, interrupt processing, or multiple processors or processor cores or on other parallel architectures, rather than sequentially. In addition, different tasks or processes can be performed by different machines and/or computing systems that can function together.

The various illustrative logical blocks and modules described in connection with the embodiments disclosed herein can be implemented or performed by a machine, such as a processing unit or processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A processor can be a microprocessor, but in the alternative, the processor can be a controller, microcontroller, or state machine, combinations of the same, or the like. A processor can include electrical circuitry configured to process computer-executable instructions. In another embodiment, a processor includes an FPGA or other programmable device that performs logic operations without processing computer-executable instructions. A processor can also be implemented as a combination of computing devices, e.g., a combination of a DSP and a microprocessor, a plurality of microprocessors, one or more microprocessors in conjunction with a DSP core, or any other such configuration. Although described herein primarily with respect to digital technology, a processor may also include primarily analog components. A computing environment can include any type of computer system, including, but not limited to, a computer system based on a microprocessor, a mainframe computer, a digital signal processor, a portable computing device, a device controller, or a computational engine within an appliance, to name a few.

Conditional language such as, among others, “can,” “could,” “might,” or “may,” unless specifically stated otherwise, are otherwise understood within the context as used in general to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment.

Disjunctive language such as the phrase “at least one of X, Y, or Z,” unless specifically stated otherwise, is otherwise understood with the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

Any process descriptions, elements or blocks in the flow diagrams described herein and/or depicted in the attached figures should be understood as potentially representing modules, segments, or portions of code which include one or more executable instructions for implementing specific logical functions or elements in the process. Alternate implementations are included within the scope of the embodiments described herein in which elements or functions may be deleted, executed out of order from that shown, or discussed, including substantially concurrently or in reverse order, depending on the functionality involved as might be understood by those skilled in the art.

Unless otherwise explicitly stated, articles such as “a” or “an” should generally be interpreted to include one or more described items. Accordingly, phrases such as “a device configured to” are intended to include one or more recited devices. Such one or more recited devices can also be collectively configured to carry out the stated recitations. For example, “a processor configured to carry out recitations A, B and C” can include a first processor configured to carry out recitation A working in conjunction with a second processor configured to carry out recitations B and C. Unless otherwise explicitly stated, the terms “set” and “collection” should generally be interpreted to include one or more described items throughout this application. Accordingly, phrases such as “a set of devices configured to” or “a collection of devices configured to” are intended to include one or more recited devices. Such one or more recited devices can also be collectively configured to carry out the stated recitations. For example, “a set of servers configured to carry out recitations A, B and C” can include a first server configured to carry out recitation A working in conjunction with a second server configured to carry out recitations B and C.

What is claimed is:

1. A system, comprising:
a non-transitory data store storing computer-executable instructions; and
a processor in communication with the non-transitory data store, wherein the computer-executable instructions, when executed by the processor, configure the processor to:
obtain a request to modify a base machine learning model according to a weight vector corresponding to a fine-tuned machine learning model;
obtain the base machine learning model and the fine-tuned machine learning model;
determine the weight vector corresponding to the fine-tuned machine learning model, wherein the weight vector represents a difference in parameter values between the fine-tuned machine learning model and the base machine learning model;
determine a selected value for a scaling coefficient used to combine the base machine learning model and the weight vector, wherein a scaling coefficient indicates a weight to be applied to the weight vector during weight vector arithmetic, at least partly by:
generating a plurality of new models by arithmetic combination of the base machine learning model and the weight vector, wherein different new models of the plurality of new models are generated using different values of the scaling coefficient;
computing perplexity values for individual new models of the plurality of new models, wherein the perplexity values for an individual new model are calculated using parallelized forward passes, and wherein the perplexity values for the individual new model are calculated according to a validation data set including both data corresponding to the base machine learning model and data corresponding to the fine-tuned machine learning model; and
selecting the selected value for the scaling coefficient based on the perplexity values for the individual new models, wherein the selected value corresponds to a first new model, of the plurality of new models, generated according to the selected scaling coefficient, and wherein the selected value is selected based on performance of the first new model relative to both the base machine learning model and the fine-tuned machine learning model; and
return the first new model in response to the request.

2. The system of claim 1, wherein the arithmetic combination of the base machine learning model and the weight vector comprises subtracting the weight vector from the base machine learning model.

3. The system of claim 1, wherein the computer-executable instructions, when executed by the processor, further configure the processor to generate the fine-tuned machine learning model by fine tuning the base machine learning model or fine tuning of a different model.

4. The system of claim 1, wherein generating the plurality of new models by arithmetic combination of the base machine learning model and the weight vector comprises generating the plurality of new models by arithmetic combination of the base machine learning model, the weight vector, and one or more additional weight vectors.

5. The system of claim 4, wherein generating the plurality of new models by arithmetic combination of the base machine learning model, the weight vector, and one or more additional weight vectors comprises:
determining, for each of the one or more additional weight vectors, a scaling coefficient, wherein the scaling coefficient for each additional weight vector determined independently of other scaling coefficients;
determining a consolidated weight vector by weighted average of the weight vector and the one or more additional weight vectors, each weight vector weighted in the weighted average according to a corresponding scaling coefficient; and
determining a selected value for a consolidated scaling coefficient used to combine the base machine learning model and the consolidated weight vector, at least partly by:
generating a plurality of new consolidated models by arithmetic combination of the base machine learning model and the consolidated weight vector, wherein different new consolidated models of the plurality of new consolidated models are generated using different values of the consolidated scaling coefficient;
computing consolidated perplexity values for individual new consolidated models of the plurality of new consolidated models; and
selecting the selected consolidated value for the consolidated scaling coefficient based on the consolidated perplexity values for the individual new consolidated models, wherein the selected consolidated value corresponds to a first new consolidated model, of the plurality of new consolidated models, generated according to the selected consolidated scaling coefficient.

6. A computer-implemented method comprising:
obtaining a request to modify a base machine learning model;
obtaining a weight vector, wherein the weight vector represents a difference in parameter values between a fine-tuned machine learning model and an additional machine learning model;
determining a selected value for a scaling coefficient used to combine the base machine learning model and the weight vector, wherein a scaling coefficient indicates a weight to be applied to the weight vector during weight vector arithmetic, at least partly by:
generating a plurality of new models by arithmetic combination of the base machine learning model and the weight vector, wherein different new models of the plurality of new models are generated using different values of the scaling coefficient;
computing perplexity values for individual new models of the plurality of new models, wherein the perplexity values for an individual new model are calculated using parallelized forward passes; and
selecting the selected value for the scaling coefficient based on the perplexity values for the individual new models, wherein the selected value corresponds to a first new model, of the plurality of new models, generated according to the selected scaling coefficient; and
returning the first new model corresponding to the selected value for the scaling coefficient in response to the request.

7. The computer-implemented method of claim 6, wherein the additional machine learning model is at least one of the base machine learning model or distinct from the base machine learning model, and wherein the request specifies at least one of the weight vector or a fine-tuned machine learning model from which the weight vector is generated.

8. The computer-implemented method of claim 6, wherein generating the plurality of new models by arithmetic combination of the base machine learning model and the weight vector comprises:
generating the plurality of new models by arithmetic combination of the base machine learning model, the weight vector, and one or more additional weight vectors,
determining, for each of the one or more additional weight vectors, a scaling coefficient, wherein the scaling coefficient for each additional weight vector determined independently of other scaling coefficients;
determining a consolidated weight vector by weighted average of the weight vector and the one or more additional weight vectors, each weight vector weighted in the weighted average according to a corresponding scaling coefficient; and
combining the base machine learning model and the consolidated weight vector.

9. The computer-implemented method of claim 8, further comprising determining a selected value for a consolidated scaling coefficient used to combine the base machine learning model and the consolidated weight vector, at least partly by:
generating a plurality of new consolidated models by arithmetic combination of the base machine learning model and the consolidated weight vector, wherein different new consolidated models of the plurality of new consolidated models are generated using different values of the consolidated scaling coefficient;
computing consolidated perplexity values for individual new consolidated models of the plurality of new consolidated models; and
selecting the selected consolidated value for the consolidated scaling coefficient based on the consolidated perplexity values for the individual new consolidated models, wherein the selected consolidated value corresponds to a first new consolidated model, of the plurality of new consolidated models, generated according to the selected consolidated scaling coefficient.

10. The computer-implemented method of claim 6, generating the weight vector.

11. The computer-implemented method of claim 6, wherein the request specifies a task or domain, and wherein obtaining the weight vector comprises identifying the weight vector by reference to metadata associating the weight vector with the task or domain.

12. The computer-implemented method of claim 6, further comprising storing the weight vector as two decomposed low-rank adaptation (LoRA) matrices.

13. The computer-implemented method of claim 6, further comprising verifying that accuracy of the first new model satisfied a threshold value prior to returning the first new model in response to the request.

14. One or more non-transitory computer-readable media comprising computer-executable instructions that, when executed by a computing system, cause the computing system to:
obtain a request to modify a base machine learning model according to a weight vector corresponding to a fine-tuned machine learning model;
obtain the weight vector corresponding to a fine-tuned machine learning model, wherein the weight vector represents a difference in parameter values between the fine-tuned machine learning model and the base machine learning model;
determine a scaling coefficient for the base machine learning model, wherein the scaling coefficient indicates a weight to be applied to the weight vector during weight vector arithmetic;
determine a selected value for a scaling coefficient used to combine the base machine learning model and the weight vector, wherein a scaling coefficient indicates a weight to be applied to the weight vector during weight vector arithmetic, at least partly by:
generating a plurality of new models by arithmetic combination of the base machine learning model and the weight vector, wherein different new models of the plurality of new models are generated using different values of the scaling coefficient;
computing perplexity values for individual new models of the plurality of new models, wherein the perplexity values for an individual new model are calculated using parallelized forward passes; and
selecting the selected value for the scaling coefficient based on the perplexity values for the individual new models, wherein the selected value corresponds to a first new model, of the plurality of new models, generated according to the selected scaling coefficient; and
return the first new model corresponding to the selected value for the scaling coefficient in response to the request.

15. The one or more non-transitory computer-readable media of claim 14, wherein the weight vector is a set of decomposed low-rank adaptation (LoRA) matrices.

16. The one or more non-transitory computer-readable media of claim 14, wherein the computer-executable instructions, when executed by the computing system, further cause the computing system to verify that accuracy of the first new model satisfied a threshold value prior to returning the first new model in response to the request.

17. The one or more non-transitory computer-readable media of claim 14, wherein generating the plurality of new models by arithmetic combination of the base machine learning model and the weight vector comprises generating the plurality of new models by arithmetic combination of the base machine learning model, the weight vector, and one or more additional weight vectors.

18. The one or more non-transitory computer-readable media of claim 17, wherein generating the plurality of new models by arithmetic combination of the base machine learning model, the weight vector, and one or more additional weight vectors comprises:
determine, for each of the one or more additional weight vectors, a scaling coefficient, wherein the scaling coefficient for each additional weight vector determined independently of other scaling coefficients;
determine a consolidated weight vector by weighted average of the weight vector and the one or more additional weight vectors, each weight vector weighted in the weighted average according to a corresponding scaling coefficient; and
combine the base machine learning model and the consolidated weight vector.

19. The one or more non-transitory computer-readable media of claim 18, wherein the computer-executable instructions, when executed by the computing system, further cause the computing system to determine a selected value for a consolidated scaling coefficient used to combine the base machine learning model and the consolidated weight vector, at least partly by:
generating a plurality of new consolidated models by arithmetic combination of the base machine learning model and the consolidated weight vector, wherein different new consolidated models of the plurality of new consolidated models are generated using different values of the consolidated scaling coefficient;
computing consolidated perplexity values for individual new consolidated models of the plurality of new consolidated models; and
selecting the selected consolidated value for the consolidated scaling coefficient based on the consolidated perplexity values for the individual new consolidated models, wherein the selected consolidated value corresponds to a first new consolidated model, of the plurality of new consolidated models, generated according to the selected consolidated scaling coefficient.

20. The one or more non-transitory computer-readable media of claim 14, wherein the computer-executable instructions, when executed by the computing system, further configure the computing system to generate the fine-tuned machine learning model by fine tuning the base machine learning model or fine tuning of a different model, wherein the arithmetic combination of the base machine learning model and the weight vector comprises adding the weight vector to the base machine learning model.
